(19) United States
(12) Patent Application Publication
(10) Pub. No.: US 2026/0019936 A1
(43) Pub. Date: Jan. 15, 2026

(54) RELAY SELECTION ASSOCIATED WITH WTRU-TO-WTRU RELAYS

(71) Applicant: InterDigital Patent Holdings, Inc., Wilmington, DE (US)

(72) Inventors: Ananth Kini, Conshohocken, PA (US); Martino M. Freda, Laval (CA); Tuong Duc Hoang, Montreal (CA); Oumer Teyeb, Montreal (CA)

(73) Assignee: InterDigital Patent Holdings, Inc., Wilmington, DE (US)

(21) Appl. No.: 18/993,890

(22) PCT Filed: Jul. 11, 2023
(86) PCT No.: PCT/US2023/027372

§ 371 Date: Jan. 13, 2025

Related U.S. Application Data
(60) Provisional application No. 63/359,949, filed on Jul. 11, 2022.

(51) Int. Cl. H04W 48/20; H04B 17/318; H04W 88/04

(52) U.S. Cl. CPC H04W 48/20; H04B 17/328; H04W 88/04

(57) ABSTRACT

Systems, methods, and instrumentalities are described herein for relay selection associated with WTRU-to-WTRU relays. A wireless transmit/receive unit (WTRU) may be configured to perform relay selection associated with WTRU-to-WTRU relays. The WTRU may (e.g., determine to) perform relay (re)selection, for example, based on active traffic and/or performed measurements (e.g., reference signal received power (RSRP) measurements). The WTRU may perform network assisted relay (re)selection. The WTRU (e.g., in coverage WTRU) may initiate a connection (e.g., RRC connection) or trigger a message (e.g., RRC message), for example, based on WTRU-to-WTRU relaying criteria. The WTRU may report measurements to the network, for example, based on multiple hops.

### CROSS-REFERENCE TO RELATED APPLICATIONS

The application claims the benefit of U.S. Provisional Application 63/359,949, filed Jul. 11, 2022, the contents of which are incorporated by reference in their entirety herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for relay selection associated with WTRU-to-WTRU relays. A wireless transmit/receive unit (WTRU) may be configured to perform relay selection associated with WTRU-to-WTRU relays. The WTRU may (e.g., determine to) perform relay (re) selection, for example, based on active traffic and/or performed measurements (e.g., reference signal received power (RSRP) measurements). The WTRU may perform network assisted relay (re) selection. The WTRU (e.g., in coverage WTRU) may initiate a connection (e.g., RRC connection) or trigger a message (e.g., RRC message), for example, based on WTRU-to-WTRU relaying criteria. The WTRU may report measurements to the network, for example, based on multiple hops.

A WTRU may determine relay reselection behavior based on measurements associated with a first relay and an active data determination (e.g., whether there is a gap between active data transmissions). A WTRU (e.g., a remote WTRU used as an example), may be associated with a first relay WTRU (e.g., WTRU-to-WTRU relay). The remote WTRU may receive configuration information that indicates thresholds (e.g., a first threshold and a second threshold) associated with sidelink (SL) RSRP (e.g., a first SL RSRP threshold and a second SL RSRP threshold where the first SL RSRP threshold is higher than the second SL RSRP threshold). The configuration information may indicate data transmission gap information (e.g., data gap transmission parameter(s)). The remote WTRU may send a first transmission to a first relay. The remote WTRU may determine SL RSRP measurement(s) associated with the first relay WTRU. The remote WTRU may determine that the SL RSRP measurement(s) associated with the first relay WTRU is below the first threshold and above the second threshold (e.g., between the first threshold and second threshold). The remote WTRU may determine (e.g., based on the determination that the SL RSRP measurement(s) is below the first threshold and above the second threshold) to perform an active data determination (e.g., for relay reselection). For example, the remote WTRU may initiate discovery (e.g., transmitting or receiving a discovery transmission). The remote WTRU may determine a duration associated with a data transmission time gap (e.g., associated with the initiated discovery). The remote WTRU may determine whether the duration associated with the data transmission time gap exceeds a data transmission gap threshold. The remote WTRU may perform relay reselection to a second relay, for example, based on a determination that the duration associated with the data transmission time gap exceeds the data transmission gap threshold. The remote WTRU may send a second transmission to the second relay.

The remote WTRU may perform relay reselection, for example, based on the SL RSRP measurement(s) (e.g., only the SL RSRP measurement(s)). For example, the remote WTRU may determine that the SL RSRP measurement(s) is below the second (e.g., lower) threshold (e.g., below both the first threshold and the second threshold). Based on the determination that the SL RSRP measurement(s) is below the second threshold, the remote WTRU may initiate discovery. The remote WTRU may perform relay reselection to a different relay, for example, without considering the data transmission gap information.

A WTRU (e.g., a remote WTRU being used as an example) may be associated with a current relay WTRU (e.g., a first relay WTRU). The remote WTRU may determine and/or pre-select a second relay or a candidate set of relays for reselection, for example, based on first condition(s)/initial trigger(s) (e.g., a current relay's link quality falling below a preselected threshold, a change in the current relay's conditions, or information from another relay). The WTRU may switch to one of the determined/preselected candidates, for example, based on second condition(s) (e.g., a condition, a trigger) being satisfied. The remote WTRU may receive (e.g., via dedicated RRC messaging or SIB) first conditions to use to determine/pre-select a second relay and/or set of candidate relays for reselection. The first conditions may include one or more of the following: a first (e.g., minimum) PC5 RSRP for relay selection; a second (e.g., different) PC5 RSRP associated with triggering a two-step relay candidate selection procedure; a time associated with completing the reselection process after initial pre-selection. The remote WTRU may be configured to (e.g., if the initial condition for pre-selection is satisfied) to pre-select one or more candidates for re-selection. The remote WTRU may (e.g., if the secondary condition(s) are satisfied, such as expiration of a time that indicates no active data transmission, an additional PC5 RSRP link quality measurement, etc.) complete the reselection process (e.g., select a pre-selected relay).

In examples, a remote WTRU may trigger a connection establishment, for example, if (e.g., when) a remote WTRU reselects to a relay WTRU and the selected relay WTRU is connected to a cell that is different than the remote WTRU. The remote WTRU may receive configuration information indicating a set of allowable relay WTRUs to which the remote WTRU may perform reselection to. The remote WTRU may receive a release message. The remote WTRU may move to RRC_IDLE/RRC_INACTIVE. The remote WTRU may perform relay reselection. The remote WTRU may initiate a connection procedure (e.g., an RRC connection procedure), for example, if the selected relay WTRU is connected to a cell that is different than the serving cell of the remote WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example user plane protocol stack for an L2 WTRU-to-Network Relay.

FIG. 3 illustrates an example control plane protocol stack for an L2 WTRU-to-Network Relay.

FIG. 4 illustrates an example protocol stack of a discovery message for a WTRU-to-Network Relay.

FIG. 5 illustrates an example of relay selection based on RSRP and active data determination.

### DETAILED DESCRIPTION

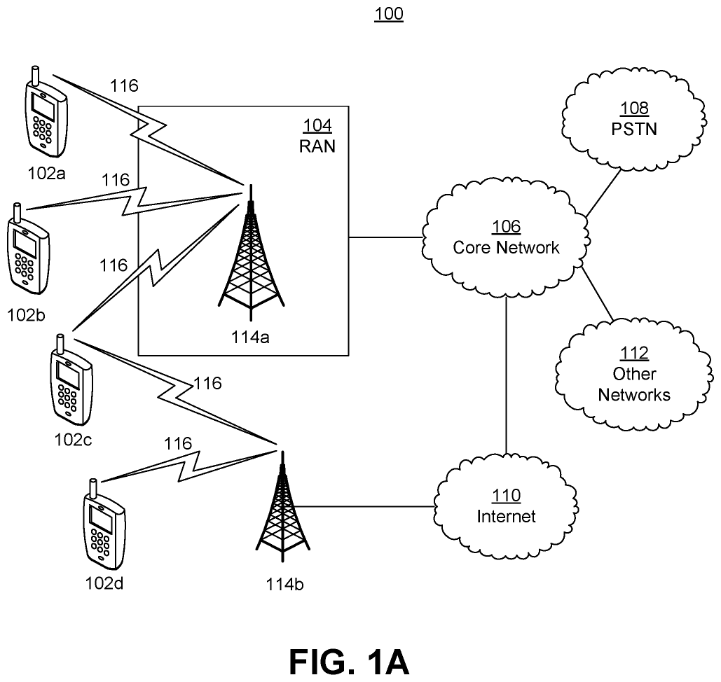

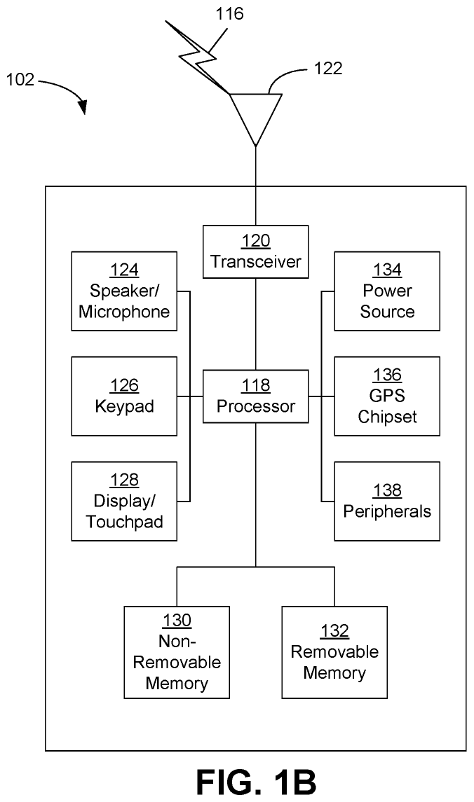

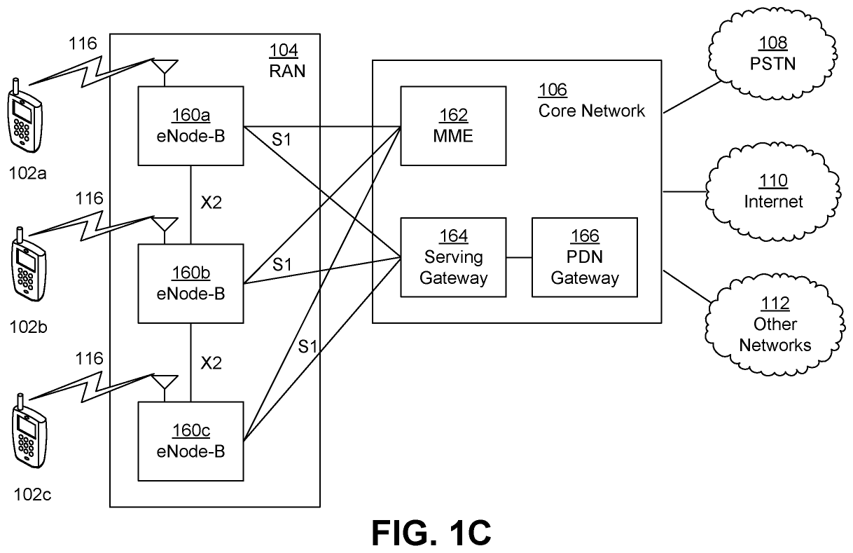

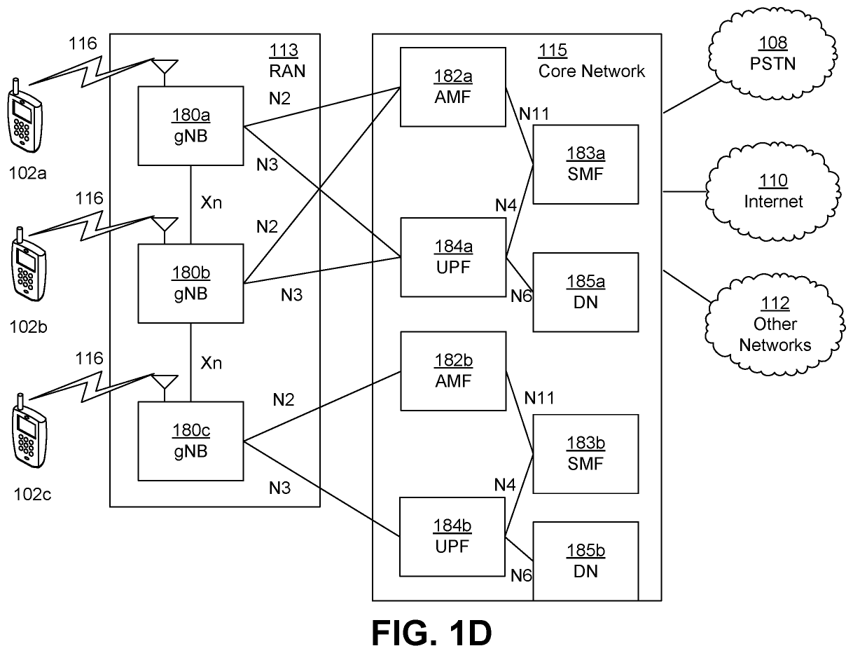

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.0

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for relay selection in WTRU-to-WTRU relays. A wireless transmit/receive unit (WTRU) may be configured to perform relay selection associated with WTRU-to-WTRU relays. The WTRU may (e.g., determine to) perform relay (re) selection, for example, based on active traffic and/or performed measurements (e.g., reference signal received power (RSRP) measurements). The WTRU may perform network assisted relay (re) selection. The WTRU (e.g., in coverage WTRU) may initiate a (e.g., RRC) connection or trigger a (e.g., RRC) message, for example, based on WTRU-to-WTRU relaying criteria. The WTRU may report measurements to the network, for example, based on (e.g., multiple) hops.

A WTRU may determine relay reselection behavior based on measurements associated with a first relay and an active data determination (e.g., whether there is a gap between active data transmissions). A WTRU (e.g., a remote WTRU), may be associated with a first relay WTRU (e.g., WTRU-to-WTRU relay). The remote WTRU may receive configuration information that indicates thresholds (e.g., a first threshold and a second threshold) associated with sidelink (SL) RSRP (e.g., a first SL RSRP threshold and a second SL RSRP threshold where the first SL RSRP threshold is higher than the second SL RSRP threshold). The configuration information may indicate data transmission gap information (e.g., data gap transmission parameter). The remote WTRU may determine SL RSRP measurement(s) associated with the first relay WTRU. The remote WTRU may determine that the SL RSRP measurement(s) associated with the first relay WTRU is below the first threshold and above the second threshold (e.g., between the first threshold and second threshold). The remote WTRU may determine (e.g., based on the determination that the SL RSRP measurement(s) is below the first threshold and above the second threshold) to perform an active data determination (e.g., for relay reselection). For example, the remote WTRU may initiate discovery (e.g., transmitting or receiving a discovery transmission). The remote WTRU may determine a duration associated with a data transmission time gap (e.g., associated with the initiated discovery). The remote WTRU may determine whether the duration associated with the data transmission time gap exceeds a data transmission gap threshold. The remote WTRU may perform relay reselection to a second relay, for example, based on a determination that the duration associated with the data transmission time gap exceeds the data transmission gap threshold.

The remote WTRU may perform relay reselection, for example, based on the SL RSRP measurement(s) (e.g., only the SL RSRP measurement(s)). For example, the remote WTRU may determine that the SL RSRP measurement(s) is below the second (e.g., lower) threshold (e.g., below both the first threshold and the second threshold). Based on the determination that the SL RSRP measurement(s) is below the second threshold, the remote WTRU may initiate discovery. The remote WTRU may perform relay reselection to a different relay, for example, without considering the data transmission gap information.

A WTRU (e.g., a remote WTRU being used as an example) may be associated with a current relay WTRU (e.g., a first relay WTRU). The remote WTRU may determine and/or pre-select a second relay or a candidate set of relays for reselection, for example, based on first condition(s)/initial trigger(s) (e.g., a current relay's link quality falling below a preselected threshold, a change in the current relay's conditions, or information from another relay). The WTRU may switch to one of the determined/preselected candidates, for example, based on second condition(s) (e.g., a condition, a trigger) being satisfied. The remote WTRU may receive (e.g., via dedicated RRC messaging or SIB) first conditions to use to determine/pre-select a second relay and/or set of candidate relays for reselection. The first conditions may include one or more of the following: a first (e.g., minimum) PC5 RSRP for relay selection; a second (e.g., different) PC5 RSRP associated with triggering a two-step relay candidate selection procedure; a time associated with completing the reselection process after initial pre-selection. The remote WTRU may be configured to (e.g., if the initial condition for pre-selection is satisfied) to pre-select one or more candidates for re-selection. The remote WTRU may (e.g., if the secondary condition(s) are satisfied, such as expiration of a time that indicates no active data transmission, an additional PC5 RSRP link quality measurement, etc.) complete the reselection process (e.g., select a pre-selected relay).

In examples, a remote WTRU may trigger a connection establishment, for example, if (e.g., when) a remote WTRU reselects to a relay WTRU and the selected relay WTRU is connected to a cell that is different than the remote WTRU. The remote WTRU may receive configuration information indicating a set of allowable relay WTRUs to which the remote WTRU may perform reselection to. The remote WTRU may receive a release message. The remote WTRU may move to RRC_IDLE/RRC_INACTIVE. The remote WTRU may perform relay reselection. The remote WTRU may initiate a connection procedure (e.g., an RRC connection procedure), for example, if the selected relay WTRU is connected to a cell that is different than the serving cell of the remote WTRU.

A WTRU (e.g., a remote WTRU being used as an example) may be associated with a current relay WTRU (e.g., a first relay WTRU). The remote WTRU may determine and/or pre-select a second relay or a candidate set of relays for reselection, for example, based on first condition(s)/initial trigger(s) (e.g., a current relay's link quality falling below a preselected threshold, a change in the current relay's conditions, or information from another relay). The WTRU may switch to one of the determined (e.g., preselected) candidates, for example, based on second condition(s) (e.g., a condition, a trigger) being satisfied. The remote WTRU may receive (e.g., via dedicated RRC messaging or SIB) first condition(s) to use to determine (e.g., pre-select) a second relay and/or set of candidate relays for reselection. The first conditions may include one or more of the following: a first (e.g., minimum) PC5 RSRP for relay selection; a second (e.g., different) PC5 RSRP associated with triggering a two-step relay candidate selection procedure; a time associated with completing the reselection process after initial pre-selection. The remote WTRU may be configured to (e.g., if the initial condition for pre-selection is satisfied) to pre-select one or more candidates for re-selection. The remote WTRU may (e.g., if the secondary condition(s) are satisfied, such as expiration of a time that indicates no active data transmission, an additional PC5 RSRP link quality measurement, etc.) complete the reselection process (e.g., select a pre-selected relay).

In examples, a remote WTRU may trigger a connection establishment, for example, if (e.g., when) a remote WTRU selects (e.g., reselects to) a relay WTRU and the selected relay WTRU is connected to a cell that is different than the remote WTRU. The remote WTRU may receive configuration information indicating a set of allowable relay WTRUs to which the remote WTRU may perform reselection to. The remote WTRU may receive a release message. The remote WTRU may change states, for example, to an idle or inactive state (e.g., move to RRC_IDLE/RRC_INACTIVE). The remote WTRU may perform relay reselection. The remote WTRU may initiate a connection procedure (e.g., an RRC connection procedure), for example, if the selected relay WTRU is connected to a cell that is different than the serving cell of the remote WTRU.

Sidelink (SL)-based WTRU to network relays may be enabled and/or used. Sidelink relay may support a (e.g., 5G) ProSe WTRU-to-Network Relay (U2N Relay) function, for example, to provide connectivity to the network for U2N Remote WTRU(s). L2 and/or L3 U2N Relay architectures may be supported. The L3 U2N Relay architecture may be transparent to the serving RAN of the U2N Relay WTRU, for example, except for controlling sidelink resources.

A U2N Relay WTRU may use (e.g., be in) RRC_CONNECTED to perform relaying (e.g., of unicast data).

For L2 U2N Relay operation, one or more of the following (e.g., RRC state combinations) may be supported: both the U2N Relay WTRU and U2N Remote WTRU may use (e.g., be in) RRC CONNECTED to perform transmission/reception of relayed unicast data; and/or; the U2N Relay WTRU can be in RRC_IDLE, RRC_INACTIVE or RRC_CONNECTED, for example, if (e.g., as long as) the (e.g., all the) U2N Remote WTRU(s) that are connected to the U2N Relay WTRU are either in RRC_INACTIVE or in RRC_IDLE.

For L2 U2N Relay, the U2N Remote WTRU may (e.g., only) use (e.g., be configured to use) a resource allocation mode (e.g., resource allocation mode 2) for data to be relayed.

A (e.g., single) unicast link may be established between a (e.g., one) L2 U2N Relay WTRU and a (e.g., one) L2 U2N Remote WTRU. The traffic of U2N Remote WTRU (e.g., via a given U2N Relay WTRU) and the traffic of the U2N Relay WTRU may be separated in different Uu RLC channels (e.g., over Uu). A L2 U2N Relay protocol architecture may be provided and/or used.

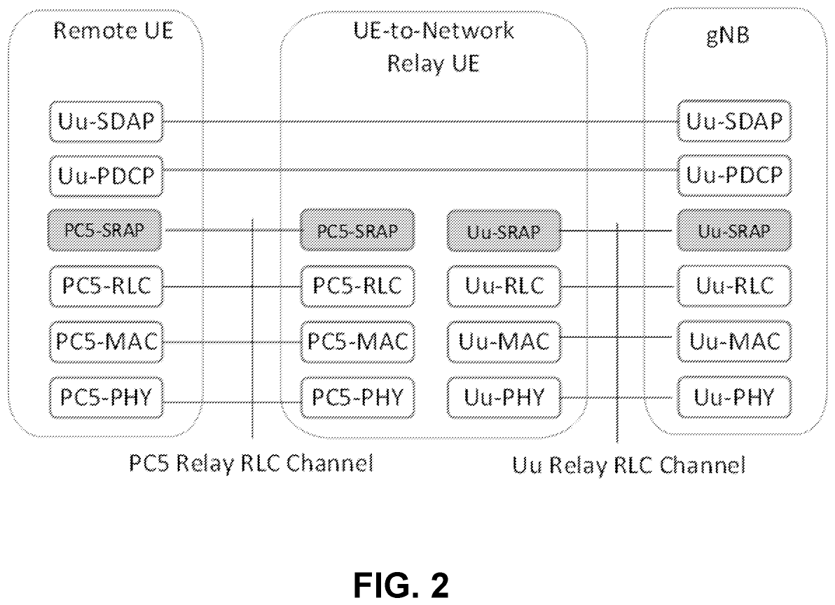

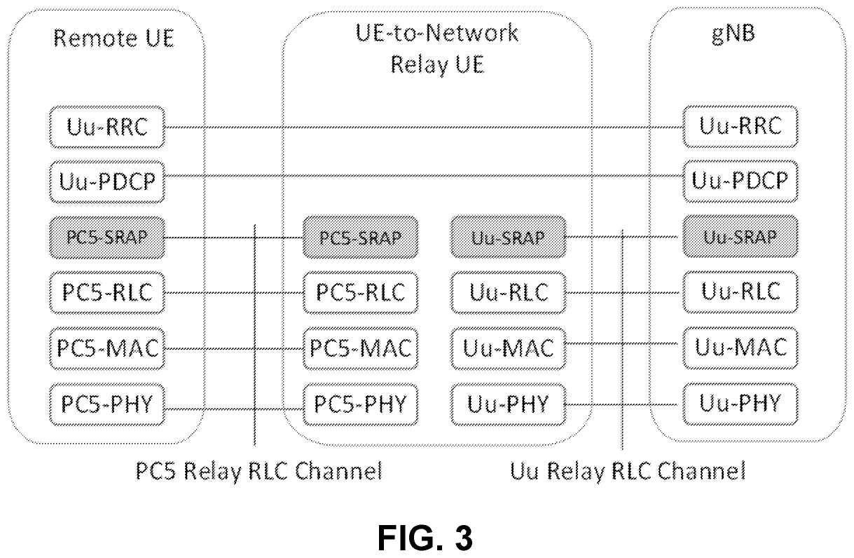

Example protocol stacks for the user plane and control plane of L2 U2N Relay architecture are presented in the figures herein. FIG. 2 illustrates an example user plane protocol stack for an L2 WTRU-to-Network Relay. FIG. 3 illustrates an example control plane protocol stack for an L2 WTRU-to-Network Relay. The SRAP sublayer may be placed above the RLC sublayer for both CP and UP at both PC5 interface and Uu interface (e.g., as shown in FIGS. 2 and 3). The Uu SDAP, PDCP and RRC may be terminated between the L2 U2N Remote WTRU and the base station (e.g., gNB), for example, as shown in FIGS. 2 and 3. The SRAP, RLC, MAC and PHY may be terminated in the (e.g., each) hop (e.g., the link between L2 U2N Remote WTRU and L2 U2N Relay WTRU and the link between L2 U2N Relay WTRU and the gNB), for example, as shown in FIGS. 2 and 3.

In examples (e.g., for a L2 U2N Relay) the SRAP sublayer over PC5 hop may be used for (e.g., only for) bearer mapping. The SRAP sublayer may not be present over the PC5 hop, for example, for relaying the L2 U2N Remote WTRU's message on BCCH and PCCH. In examples, in a (e.g., L2 U2N Remote WTRU's) message on SRB0, the SRAP sublayer may not be present over the PC5 hop. The SRAP sublayer may be present over Uu hop (e.g., for both DL and UL).

In examples (e.g., for a L2 U2N Relay for uplink), the Uu SRAP sublayer may support a (e.g., UL) bearer mapping between ingress PC5 Relay RLC channels (e.g., for relaying and egress Uu Relay RLC channels over the L2 U2N Relay WTRU Uu interface). The (e.g., different) end-to-end RBs (e.g., SRBs or DRBs) of the same Remote WTRU and/or different Remote WTRUs can be multiplexed (e.g., over the same Uu Relay RLC channel), for example, for uplink relaying traffic.

In examples (e.g., for a L2 U2N Relay for uplink), the Uu SRAP sublayer may support an L2 U2N Remote WTRU identification (e.g., for the UL traffic). The identity information (e.g., of an L2 U2N Remote WTRU Uu Radio Bearer and/or a local Remote WTRU ID) may be included in the Uu SRAP header at UL, for example, in order for a base station (e.g., gNB) to correlate the received packets for the (e.g., specific) PDCP entity associated with the associated Uu Radio Bearer of a Remote WTRU. The PC5 SRAP sublayer (e.g., at the L2 U2N Remote WTRU) may support (e.g., UL) bearer mapping, for example, between Remote WTRU Uu Radio Bearers and egress PC5 Relay RLC channels.

In examples (e.g., for a L2 U2N Relay, for downlink), the Uu SRAP sublayer may support DL bearer mapping at a base station (e.g., gNB) to map end-to-end Radio Bearer (e.g., SRB, DRB) of Remote WTRU into a Uu Relay RLC channel over a Relay WTRU Uu interface. The Uu SRAP sublayer may support DL bearer mapping and/or data multiplexing between multiple end-to-end Radio Bearers (e.g., SRBs or DRBs) of a L2 U2N Remote WTRU and/or different L2 U2N Remote WTRUs and/or a (e.g., one) Uu Relay RLC channel over the Relay WTRU Uu interface.

In examples (e.g., for a L2 U2N Relay, for downlink), the Uu SRAP sublayer may support Remote WTRU identification (e.g., for DL traffic). The identity information (e.g., of a Remote WTRU Uu Radio Bearer and a local Remote WTRU ID) may be included into the Uu SRAP header (e.g., by the gNB at DL), for example, in order for a Relay WTRU to map the received packets from Remote WTRU Uu Radio Bearer to its associated PC5 Relay RLC channel.

In examples (e.g., for a L2 U2N Relay, for downlink), the PC5 SRAP sublayer (e.g., at the Relay WTRU) may support DL bearer mapping, for example, between ingress Uu Relay RLC channels and egress PC5 Relay RLC channels.

In examples (e.g., for a L2 U2N Relay, for downlink), the PC5 SRAP sublayer (e.g., at the Remote WTRU) may correlate the received packets for the specific PDCP entity associated with the associated Uu Radio Bearer of a Remote WTRU, for example, based on the identity information included in the Uu SRAP header.

A local Remote WTRU ID may be included in a header (e.g., PC5 SRAP header and/or a Uu SRAP header). A relay WTRU (e.g., L2 U2N Relay WTRU) may be configured by the base station (e.g., gNB) with the local Remote WTRU ID, for example, to be used in SRAP header. The Remote WTRU may obtain the local Remote ID from the base station (e.g., gNB), for example, via Uu RRC messages (e.g., including RRCSetup, RRCReconfiguration, RRCResume and/or RRCReestablishment). A Uu DRB(s) and/or Uu SRB(s) may be mapped to different PC5 Relay RLC channels and Uu Relay RLC channels (e.g., in both PC5 hop and Uu hop).

The base station (e.g., gNB) may be responsible for avoiding collision on the usage of a local Remote WTRU ID. The base station (e.g., gNB) can update the local Remote WTRU ID, for example, by sending the updated local Remote ID (e.g., via a message (e.g., RRCReconfiguration message) to the Relay WTRU. The serving base station (e.g., gNB) can perform the local Remote WTRU ID update, for example, independent of the PC5 unicast link L2 ID update procedure.

Discovery may be enabled and/or performed.

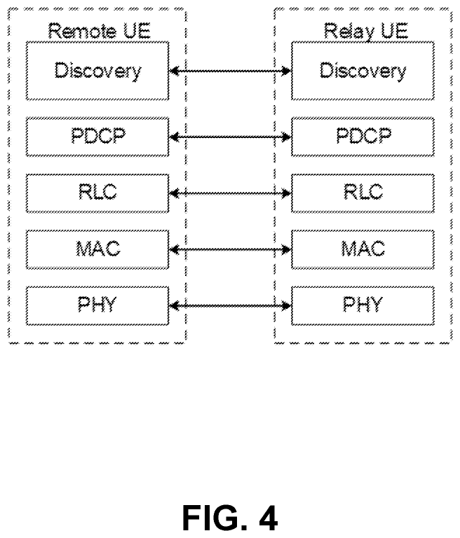

Discovery models may be supported for U2N Relay discovery. For example, Model A and Model B discovery models may be supported for U2N Relay discovery. FIG. 4 illustrates an example protocol stack of a discovery message for a WTRU-to-Network Relay. As shown in FIG. 4, a protocol stack used for discovery may be provided.

The U2N Remote WTRU can perform Relay discovery message transmission. The U2N Remote WTRU may monitor the sidelink for a Relay discovery message, for example, while in RRC_IDLE, RRC_INACTIVE or RRC_CONNECTED. The network may broadcast a threshold. The threshold may be used (e.g., by the U2N Remote WTRU) to determine if it can transmit Relay discovery solicitation messages (e.g., to U2N Relay WTRU(s)).

The U2N Relay WTRU can perform Relay discovery message transmission and/or may monitor the sidelink for a Relay discovery message while in RRC_IDLE, RRC_INACTIVE or RRC_CONNECTED. The network may broadcast an RSRP threshold (e.g., maximum Uu RSRP threshold, a minimum Uu RSRP threshold, or both), for example, which may be used by the U2N Relay WTRU (e.g., to determine if it can transmit Relay discovery messages to U2N Remote WTRU(s).

The network may provide Relay discovery configuration information, for example, using broadcast or dedicated signaling for Relay discovery. The U2N Remote WTRU and/or U2N Relay WTRU may use configuration information (e.g., a pre-configuration) for Relay discovery.

The resource pool(s) (e.g., used for NR sidelink communication) can be used for Relay discovery. The network may configure a resource pool(s) dedicated for Relay discovery. Resource pool(s) dedicated for Relay discovery can be configured (e.g., simultaneously) with resource pool(s) for NR sidelink communication, for example, in system information, dedicated signaling, and/or pre-configuration. Whether a dedicated resource pool(s) for Relay discovery is configured may be based on network implementation. The resource pool(s) dedicated for Relay discovery (e.g., only the resource pool(s) dedicated for Relay discovery) may be used for Relay discovery, for example, if the resource pool(s) dedicated for Relay discovery are configured. The configured transmission resource pool(s) (e.g., all the configured transmission resource pool(s)) can be used for Relay discovery and sidelink communication, for example, if (e.g., only) resource pool(s) for (e.g., NR) sidelink communication are configured.

In examples, for a U2N Remote WTRU (e.g., which may include both in-coverage and out of coverage cases) that has been connected to the network (e.g., via a U2N Relay WTRU), (e.g., only) resource allocation mode 2 may be used for discovery message transmission.

Relay selection (e.g., reselection) may be performed.

The remote WTRU (e.g., U2N Remote WTRU) may perform measurements (e.g., radio measurements, such as RSRP measurements). The (e.g., U2N) remote WTRU may perform radio measurements at the PC5 interface. The remote WTRU may use the measurements, for example, for U2N Relay selection and reselection (e.g., along with higher layer criteria). The remote WTRU (e.g., U2N Remote WTRU) may use SD-RSRP measurements to evaluate whether a link quality (e.g., PC5 link quality) towards a U2N Relay WTRU satisfies a relay selection criterion as discussed herein. For example, if (e.g., when) there is no unicast PC5 connection between the U2N Relay WTRU and the U2N Remote WTRU.

In examples (e.g., for relay reselection) the remote WTRU (e.g., U2N Remote WTRU) may use (e.g., SL-RSRP) measurements towards the serving WTRU (e.g., U2N Relay WTRU) for a relay reselection trigger evaluation, for example, if (e.g., when) there is data transmission from the (e.g., U2N) Relay WTRU to the (e.g., U2N) Remote WTRU. It may be left to WTRU implementation whether to use SL-RSRP or SD-RSRP for relay reselection trigger evaluation, for example, in case of no data transmission from U2N Relay WTRU to U2N Remote WTRU.

A relay (e.g., U2N Relay) WTRU may be considered suitable (e.g., by a U2N Remote WTRU) in terms of radio criteria, for example, if the PC5 link quality measured by U2N Remote WTRU towards the U2N Relay WTRU exceeds a configured threshold (e.g., pre-configured or provided by gNB). The U2N Remote WTRU may search for suitable U2N Relay WTRU candidates that meet (e.g., all AS layer and higher layer) criteria. It may be up to U2N Remote WTRU implementation to choose a (e.g., one) U2N Relay WTRU among them, for example, if there are multiple such suitable U2N Relay WTRUs. For (e.g., L2 U2N Relay) (re) selection, the PLMN ID and cell ID can be used as additional (e.g., AS) criteria.

The remote WTRU (e.g., U2N Remote WTRU) may trigger (e.g., U2N) Relay selection based on one or more of the following: (e.g., direct Uu) signal strength of the current serving cell of the (e.g., U2N) Remote WTRU is below a configured signal strength threshold; an indication (e.g., by upper layer of the U2N Remote WTRU); and/or the like.

The (e.g., U2N) Remote WTRU may trigger (e.g., U2N) Relay reselection based on one or more of the following: (e.g., PC5) signal strength of a (e.g., current U2N) Relay WTRU is below a (pre) configured signal strength threshold; cell (re) selection, handover, or (e.g., Uu) RLF has been indicated by a (e.g., U2N) Relay WTRU (e.g., via PC5-RRC signaling); if (e.g., when) a Remote WTRU receives a (e.g., PC5-S) link release message from a (e.g., U2N) Relay WTRU; if (e.g., when) a (e.g., U2N) Remote WTRU detects (e.g., PC5) RLF; an indicating (e.g., by upper layer).

For L2 U2N Remote WTRUs (e.g., in RRC_IDLE/INACTIVE) and/or L3 U2N Remote WTRUs, the cell (re) selection procedure and relay (re) selection procedure may run independently. It may be up to WTRU implementation to select a cell or a U2N Relay WTRU, for example, if both suitable cells and suitable U2N Relay WTRUs are available. A L3 U2N Remote WTRU may select a cell and a U2N Relay WTRU (e.g., simultaneously), for example, which may be up to implementation of L3 U2N Remote WTRU.

For L2 and L3 U2N Relay WTRUs (e.g., in RRC_IDLE/INACTIVE), the (e.g., PC5-RRC) message(s) may be used to inform their associated (e.g., connected) Remote WTRU(s), for example, if (e.g., when) U2N Relay WTRUs select a (e.g., new) cell. The (e.g., PC5-RRC) message(s) may be used to inform their associated (e.g., connected) L2 or L3 U2N Remote WTRU(s), for example, if (e.g., when) the L2/L3 U2N Relay WTRU performs a handover or detects (e.g., Uu) RLF. It may be up to (e.g., U2N) Remote WTRU implementation whether to release or keep the unicast (e.g., PC5) link, for example, based on reception of the PC5 RRC message for notification. The U2N Remote WTRU may trigger the L2 release procedure and may perform relay reselection, for example, if the U2N Remote WTRU determines (e.g., decides) to release the unicast PC5 link.

Relay selection/reselection rules (e.g., for WTRU to NW relays) may be specified, provided, and/or used. These rules may be based (e.g., predominantly) on the consideration of RSRP measurements on sidelink for the remote WTRU (e.g., to determine which relay to select). WTRU to WTRU relays may be specified and relay selection rules may (e.g., need to) be considered. A number of differences may exist between U2N and U2U, for example, which may make the existing U2N relay (re) selection rules not directly applicable to U2U relays.

WTRU-based relay selection for U2N relays may be used, for example, if (e.g., when) the remote WTRU is in RRC_IDLE/RRC_INACTIVE. In this case (e.g., the remote WTRU is in RRC_IDLE/RRC_INACTIVE), the remote WTRU may not have active data for transmission. For a remote WTRU (e.g., in RRC_CONNECTED), mobility may be controlled by the base station (e.g., gNB). For U2U relays (e.g., specifically for the out of coverage scenario), the gNB may not be involved in the mobility decisions. Relay (re) selection decisions (e.g., specifically if performed often) may affect latency associated with ongoing data transmissions. RSRP-based (re) selection decisions (e.g., alone) may not be appropriate in this case.

WTRU-based relay selection (e.g., for U2N relays) may use the quality of the SL hop (e.g., only). This may be based on the assumption that the Uu hop quality may be ensured to be acceptable by the relay operation thresholds (e.g., configured to the U2N relay). In examples (e.g., for U2U relays), relay selection/reselection rules may consider both hops. The measurements of both hops may not be available at the deciding WTRU and/or also by the fact that such measurements may be made using different mechanisms (e.g., SL-RSRP vs SD-RSRP) on each link.

U2N relays may have a (e.g., very simple) connectivity architecture and network coverage. Specifically, the remote WTRU may be assumed to be out of coverage, for example, while the relay WTRU may be assumed to be in coverage. The remote WTRU may be assumed to have a (e.g., single) unicast link with the relay WTRU. The relay WTRU may have a (e.g., legacy RRC) connection with the network. A U2U relay can have (e.g., more) variations of topology and coverage situations, for example, such as one or multiple (e.g., two or all) of the WTRUs either in coverage or out of coverage, and/or operating in mode1/mode2, as well as same or different relays serving a (e.g., single) source WTRU with (e.g., multiple) connections to different destinations or vice versa. A WTRU can be using both a U2N relay and a U2U relay. The factors as described herein may be considered in selection of an appropriate relay.

A WTRU may determine to perform and/or perform relay reselection, for example, based on active traffic.

In examples, a WTRU may determine (e.g., any of) relay selection rules, relay selection criteria, if (e.g., when/whether) to trigger relay reselection, the (e.g., specific) relay selection procedure to follow, or similar behavior related to relay selection (e.g., based on the presence and/or type of active traffic transmitted/received from the relay). The advantage may be to avoid frequent relay (re) selection procedures (e.g., which may involve loss or delay of relayed sidelink data), for example, that may occur if (e.g., when) the WTRU performs active data transmission.

Detection of active data and/or type of data may be performed and/or enabled.

A WTRU may determine the presence/type of active data. A WTRU may determine the presence/type of active data, for example, based on one or more of the following: presence of an end-to-end unicast link; an amount of data transmitted via a unicast link, an amount of time since the last data transmission (e.g., data transmission time gap), the QoS associated with the data; and/or the like.

A WTRU may determine the presence/type of active data, for example, based on a presence of an end-to-end unicast link. A remote WTRU may determine that active data is present, for example, if (e.g., when) the remote WTRU is configured with an adaptation layer. A remote WTRU may determine that active data is present, for example, if (e.g., when) the remote WTRU is configured with an end-to-end source/destination L2 ID, unicast link, or similar (e.g., which may be possibly associated with transmission via a relay).

A WTRU may determine the presence/type of active data, for example, based on an amount of data transmitted via a unicast link. In examples, a remote WTRU may consider an increase (e.g., sudden increase) in data intended for a target WTRU. This may be based on an increase in buffered data at the WTRUs, or (e.g., sudden) increase in throughput on the unicast link. The remote WTRU may consider active data to be present, for example, if the increase in the buffered data is above a threshold. In examples, a remote WTRU may consider a variation (e.g., large variation) in data volume over some time (e.g., averaging) window on the unicast link. This may be based on a configured threshold value. The remote WTRU may consider active data on the link, for example, if the data volume over a preconfigured time window is above a threshold.

A WTRU may determine the presence/type of active data, for example, based on the amount of time since the last data transmission. The state of the buffer status at remote WTRU (e.g., if the buffer is growing/depleting, rate of depletion, age of packets in system, etc.) may be used to infer time since last data transmission. A duration (e.g., tracked via a timer) which may be configured to be reset after every transmission or reception (e.g., data transmission, discovery transmission, discovery reception) may be used to keep track of time since last data transmission, age of link, etc. In examples, the remote WTRU may utilize a (e.g., SL-RSRP) measurement status (e.g., a time that last SL-RSRP was measured) to keep track of last data transmission/time since last data transmission on the unicast link.

A WTRU may determine the presence/type of active data, for example, based on the QoS associated with the data. A remote WTRU may consider a change in characteristics of the data (e.g., new LCGs/DRBs with different/higher priority levels as triggered by application layer data) as activity. The QoS of the data transmitted over the relayed link may be used to determine the parameters for activity state determination. For example, the type of QoS data may be used to determine a measurement window and/or a measurement parameter for selection. For example, lower latency data may use (e.g., need) a smaller measurement window for quicker selection of relay and/or also prioritizing a path with a lower hop count (e.g., path with fewer hopsbetween source and target). CSI/CQI may also be used as a selection criterion. CSI/CQI may also be used as a selection criterion, for example, in addition to considering RSRP of the hop(s) (e.g., each hop). If data has higher bandwidth requirement, then in addition to RSRP of the hop(s) (e.g., each hop), CSI/CQI may be used as a selection criterion, for example, where if a source has multiple paths that satisfy PC5 link quality, it may use CSI quality for deciding between these links.

Relay selection behavior may depend on a determination of a presence and/or type of (e.g., active data.

A WTRU may determine (e.g., select) a relay selection behavior to perform, for example, based on the determination of the presence/type of active data (e.g., based on a transmission time gap). Relay selection behavior may be determined, for example, based on the determination of active data (e.g., as described herein, for example, such as based on a transmission time gap). The WTRU may consider other criteria (e.g., RSRP measurements), for example, in addition to the determination of active data. For example, the WTRU may consider (e.g., in addition to the determination of active data) one or more of the following: determining the criteria for triggering relay (re) selection; determining the criteria for an acceptable relay; determining whether to perform discovery procedure (e.g., transmission and/or reception or discover) and/or the discovery resource pool to use; determining whether to delay relay (re) selection (e.g., to a later time); determining whether to perform (re) selection for a second and/or potential relay; and/or the like.

A WTRU may determine (e.g., select) a relay selection behavior to perform, for example, based on a determination of the criteria for triggering relay (re) selection. For example, criteria for triggering relay (re) selection may be associated with the age of data in a WTRUs buffer. A relay reselection may be triggered, for example, if the age of data in the WTRUs buffer exceeds (e.g., goes above) a certain threshold value. A WTRU configured with an inactivity time (e.g., where the inactivity time may be reset at end of last data transmission), may trigger a relay selection event, for example, based on expiration (e.g., on the inactivity time). The inactivity time may be tracked (e.g., via a timer).

For example, criteria for triggering relay (re) selection may be associated with CSI information (e.g., if available to remote WTRU, for example, from the WTRU-WTRU relay). In examples, the quality of the CSI report provided by relay WTRU if (e.g., when) requested by remote WTRU may trigger a reselection event. An expiration of a time (e.g., via a timer), for example, if a remote WTRU does not receive a CSI report (e.g., within a duration of time (e.g., maximum amount of time)), may trigger a relay reselection event.

A WTRU may determine (e.g., select) a relay selection behavior to perform, for example, based on determining the criteria for an acceptable relay. For example, criteria for an acceptable relay may be associated with the data rate (e.g., current/instantaneous and/or min/max data rate) supported by the WTRU-WTRU relay. Criteria for an acceptable relay may be associated with the data rate used by the Remote WTRU (e.g., required data rate, for example, such as instantaneous, peak, average, etc.) Criteria for an acceptable relay may be associated with the capability (e.g., supported QoS/reliability/latency capability) of the relay WTRU, for example, if this is available to remote WTRU (e.g., via a discovery message). Criteria for an acceptable relay may be associated with a measurement (e.g., SL-RSRP) for the WTRU-WTRU relay, for example, which may include RSRP for both relay-source as well as relay-target direction (e.g., if available, for example, based on previous/recent transmission.) Criteria for an acceptable relay may be associated with a quality of a CSI report for relay WTRUs (e.g., if available).

A WTRU may determine (e.g., select) a relay selection behavior to perform, for example, based on determining whether to perform a discovery procedure (e.g., transmission and/or reception of discovery) and/or the discovery resource pool to use. A (e.g., relay) WTRU may decide to transmit and/or forward the discovery message, for example, if the SL-RSRP or SD-RSRP is above a certain threshold. This threshold may be based on a QoS requirement. A certain SL-RSRP value/range may be able to support (e.g., only) certain QoS. A higher or more stringent QoS requirement may use (e.g., require) a different SL-RSRP/SD-RSRP. A WTRU may decide to use a specific resource pool, for example, based on the characteristics of data that is being served. This can be based on QoS of data (e.g., priority, reliability, latency/PDB etc.), volume of data being served, etc. A WTRU configured with both dedicated and shared resource pools may choose to use a dedicated pool for data with a high QoS value, for example, whereas lower QoS data may result in use of a shared resource pool for discovery messages. A WTRU may utilize information tied to a received discovery message, for example, to determine whether to forward a discovery message. This may be information such as the resource pool that the message was received on, the number of sub-channels occupied by discovery message, CBR of the resource pool, RSRP of received discovery message, hop count of discovery message (e.g., if available), hop count to target WTRU (e.g., if available), potential likelihood of success that this can be a successful relay between source/remote and target WTRUs (e.g., which may be based on number WTRUs this relay WTRU is currently serving, load of the relay, SL-RSRP/SD-RSRP levels to neighboring WTRUs based on some historical context, etc.), and/or the like. A relay may decide to transmit and/or forward a data discovery message, for example, based on the resource pool this message was received on and/or if there is a (e.g., pre-configured) mapping between resource and transmit resource pools (e.g., which may indicate an automatic forwarding configuration for discovery messages).

A WTRU may determine (e.g., select) a relay selection behavior to perform, for example, based on determining whether to delay relay (re) selection to a later time. A WTRU may start reselection and decide on a set of relay candidates for re-selection. The WTRU may track a duration (e.g., start a timer) or wait for another trigger event (e.g., it had an ongoing data transmission, that has now completed). The WTRU may detect a (e.g., new) discovery message from a relay WTRU(s) (e.g., in the same set or new candidate that may provide additional information which may help the WTRU in making a selection). If the WTRU has detected this secondary trigger or if the duration has expired (e.g., via the timer), the WTRU may initiate reselection of the (e.g., new) relay. The information (e.g., new information) may include information associated with the relay WTRUs capabilities (e.g., load, data rate, supported QoS, SL-RSRP/SD-RSRP, etc.) The WTRU may utilize information obtained in this time window (e.g., between the first and second triggers), for example, to gather additional data and or perform some time averaging (e.g., over RSRP, load etc.) in consideration for deciding on which relay to switch to.

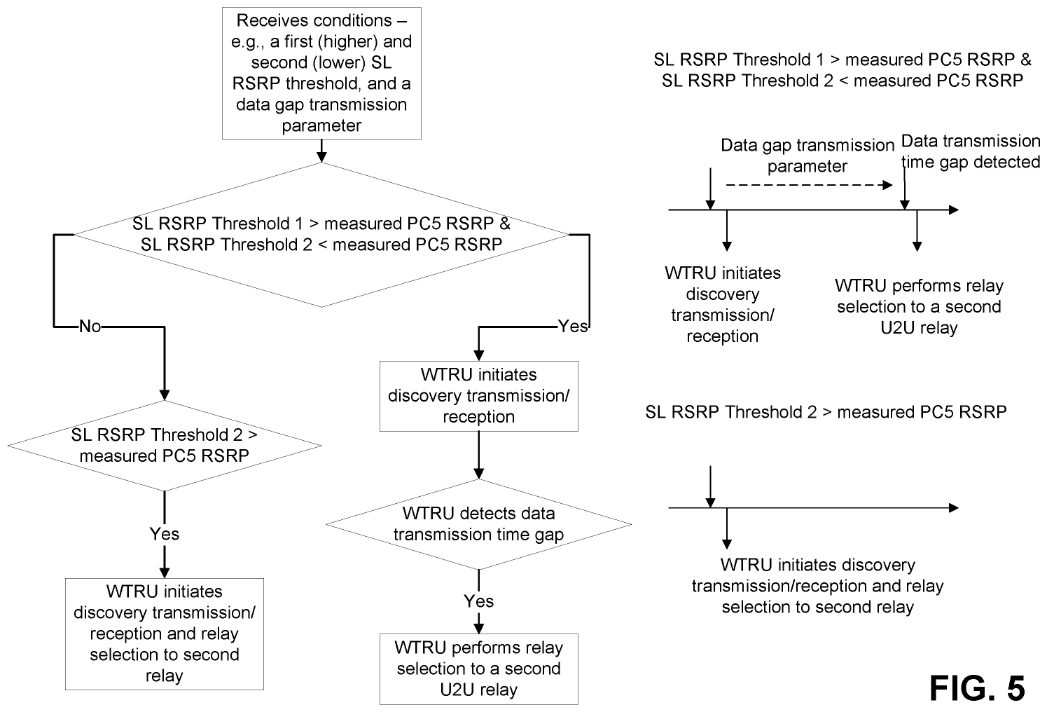

FIG. 5 illustrates an example of relay selection behavior as discussed herein, e.g., based on measurement(s) (e.g., RSRP) and active data determination. A WTRU may determine (e.g., select) a relay selection behavior to perform, for example, based on determining whether to perform (re) selection for a second/potential relay. A WTRU may trigger a (re) selection of a secondary relay, for example, as a means of reducing switching time between relays. This may be based on configuration information (e.g., that indicates conditions and/or thresholds (e.g., a first (e.g., higher) threshold and a second (e.g., lower) threshold) associated with SL RSRP and/or a data gap transmission parameter, as discussed herein and as shown in FIG. 5) and triggered by an event, for example, such as one or more of: a (e.g., current) relay(s) link quality falling below (e.g., is less than) a threshold (e.g., within some margin\delta of the RSRP threshold or a second SL-RSRP threshold that may be within some margin of the minimum RSRP for reselection, a change in (e.g., remote) WTRUs buffer status that may be indicative of an insufficient rate of depletion with current relay, etc.), a type of QoS that this relay may or may not support, etc. The remote WTRU may trigger relay selection of a second relay if (e.g., when) the measurement (e.g., RSRP) of the (e.g., current) relay falls below a threshold (e.g., Theshold 2 (e.g., a lower threshold of two thresholds) as shown in FIG. 5), for example, if the priority of the data transmitted via the relay is above a threshold. The remote WTRU may change the relay to the second relay using a reselection procedure that considers (e.g., with higher priority) relays (e.g., any potential relays) already selected, for example, if the measurement (e.g., RSRP) of the (e.g., current) relay falls below a second threshold (e.g., a lower threshold of two threshold, for example, Threshold 2 as shown in FIG. 5).

A combination of relay selection criteria (e.g., SL RSRP measurements, as shown in FIG. 5) and active data determination (e.g., as shown in FIG. 5) may comprise one or more of the following: active data determination (e.g., whether or not there is active data, for example if a data transmission gap threshold is met) may be used as a condition for triggering reselection, for example, if (e.g., only if) the relay selection condition meets a condition (e.g., see FIG. 5). Otherwise reselection may be skipped (e.g., not be used). The parameters or conditions for determining active data may be configured based on measurements (e.g., SL RSRP measurements).

A combination of relay selection criteria (e.g., SL RSRP measurements) and active data determination may comprise a form where active data determination (e.g., whether or not there is active data, for example, if a data transmission gap threshold is met) may be used as a condition for triggering relay reselection (e.g., only) if the traditional relay selection condition meets (e.g., some) a condition (e.g., if an SL RSRP measurement is above/below a threshold, if an SL RSRP measurement is between two thresholds, etc., as shown in FIG. 5). Otherwise, it may not be used. The remote WTRU may use active data determination to determine whether to trigger relay reselection, for example, if the measurement (e.g., SL RSRP) is measured to be in a first range (e.g., larger than a first threshold and smaller than a second threshold, as shown in FIG. 5). The WTRU may consider (e.g., only) measurement (e.g., SL RSRP measurement) condition to trigger relay reselection (e.g., initiate discovery (e.g., discovery transmission/reception) and perform relay selection, as shown in FIG. 5), for example, if the SL RSRP is below the first threshold or above the second threshold (e.g., as shown in FIG. 5).

A combination of relay selection criteria (e.g., SL RSRP measurements) and active data determination may include using parameters or conditions for determining active data (e.g., data gap transmission parameter, as shown in FIG. 5), for example, which may be configured based on (e.g., SL RSRP) measurements (e.g., a data transmission time gap threshold may be determined based on SL RSRP measurement(s), for example, where a higher SL RSRP measurement may be associated with a higher data transmission time gap threshold and a lower SL RSRP measurement may be associated with a lower data transmission time gap threshold). The threshold period of time over which no active data transmission is observed (e.g., for triggering reselection) may be dependent on the measurement (e.g., SL RSRP). The WTRU may receive configuration information indicating (e.g., be configured with) a first (e.g., large) period of time with no active data before triggering relay reselection if (e.g., when) the measured SL RSRP is high and may receive configuration information indicating (e.g., be configured with) a second (e.g., small) period of time with no active data before triggering relay reselection if (e.g., when) the measured SL RSRP is low. The remote WTRU may determine whether a data transmission time gap is detected, for example, based on the threshold period of time with no active data (e.g., based on tracking a time after the WTRU initiates discovery transmission/reception, as shown in FIG. 5). Based on a determination that a data transmission time gap is detected, the remote WTRU may (e.g., opportunistically) perform relay selection to a second U2U relay. The remote WTRU may receive configuration information indicating (e.g., be configured with) a prohibit time (e.g., prohibit timer) between triggers of relay reselection (e.g., following a first reselection, the remote WTRU may refrain from triggering (e.g., not trigger) a second relay reselection for a period of time given by the prohibit time). The WTRU may determine the value of the prohibit time (e.g., prohibit timer), for example, based on the measured RSRP.

The WTRU may perform network assisted relay (re) selection.

In examples, relay selection by a remote WTRU may be controlled by conditions and/or restrictions (e.g., provided by the network). Examples of network control may include one or more of the following: the remote WTRU may limit relay selection to a list of relays that are allowed or not allowed as relay reselection targets; the remote WTRU may be allowed to perform relay reselection or may use (e.g., require) relay reselection to be performed by the network and indicated to the remote WTRU, for example, where if performed by the network, the remote WTRU may receive the specific relay WTRU to which relay reselection should be performed; the remote WTRU may receive an accept or reject of a selected relay following the remote WTRU reporting the selected relay to the network; etc.

Network control may be enabled and/or used (e.g., possible) for remote WTRUs in coverage and/or in RRC_CONNECTED.

In examples, for a WTRU that does not have any candidates that satisfy criteria, a base station (e.g., gNB) may provide the WTRU with a temporary candidate or a temporary candidate that the base station knows can meet the remote WTRU's needs either temporarily or until the WTRU can select one on its own (e.g., one that satisfies reselection criteria).

The WTRU may be configured a set of relays by the network. The WTRU may exclude (e.g., relay) WTRUs that may not be in this set as potential candidates for relay selection. This may be beneficial from a WTRU processing as well as a latency point of view.

In examples, a WTRU may refrain from (e.g., be disabled from) performing relay selection. For example, the network may be aware that the WTRU is performing (e.g., frequent) relay (re) selections and ping-ponging between relays (e.g., which may cause (e.g., excessive) signaling and/or impact other WTRUs). Such a scenario may indicate that the WTRU is lacking information (e.g., some critical information) and/or is experiencing poor channel conditions. The base station (e.g., gNB) or network may take over and provide the WTRU with a relay WTRU or (e.g., alternatively) pause relay selection, for example, until some later time (e.g., via a reconfiguration message or time expiration, etc.) at which point a reselection event may be triggered.

In examples, the WTRU may receive an indication and/or trigger for relay selection from the network. This may be in addition to a (e.g., any) pre-configuration for relay discovery (e.g., RSRP thresholds, resource pools etc.) the network may provide to WTRUs, for example, where the WTRU may refrain from initiating (e.g., not be able to initiate) a discovery procedure (e.g., even it is preconfigured for relay discovery), e.g., until it receives this explicit indication or trigger from the network. This indication may be associated with a time (e.g., timer), for example, at the expiration of which the WTRU may have to wait for another indication or trigger before it can initiate a discovery procedure.

In examples, a WTRU may be disabled from performing (e.g., any) discovery and relay selection. The network may provide the WTRU with a (e.g., specific) relay that the WTRU is (e.g., needs) to select. This may be temporary and may be triggered by factors, for example, such as measurements made by the remote WTRU, an excessive load on a relay WTRU, WTRUs ping-ponging between relays (e.g., due to excessive reselections being triggered), etc. In examples, a WTRU may provide the network or gNB with assistance information regarding active/connected relays and/or candidate relays, for example, including active connection and discovery related measurements (e.g., SL-RSRP, SD-RSRP, etc.) The network may use this assistance information in conjunction with any additional information the network may be aware of (e.g., relay load, relay hop count from/to source and target WTRU, WTRUs resource pool configuration etc.) in order to assist the WTRU with relay selection, for example, by providing updated configuration information (e.g., such as a candidate set of relays for relay selection, or alternately a specific relay that the WTRU should use either temporarily or for some fixed duration of time after which the WTRU may revert to selection).

A WTRU can determine its relay selection behavior (e.g., restrictions) and/or network interaction. A WTRU can determine its relay selection behavior (e.g., restrictions) and/or network interaction based on one or more of the following factors: RRC state of the remote WTRU; resource allocation; QoS of data; and/or the like.

A WTRU can determine its relay selection behavior (e.g., restrictions) and/or network interaction based on the RRC state of remote WTRU. A WTRU that is in RRC IDLE/INACTIVE and out-of-coverage (OOC) may select from a (e.g., any) relay WTRU that satisfies the selection criteria (e.g., based on certain pre-configured parameters). The WTRU may have a (e.g., preconfigured) list of relays it may (e.g., be allowed to) select from. The WTRU may (e.g., alternatively) select from any available relay WTRUs that satisfy the (e.g., PC5) link quality, for example, if there is no such list.

In examples, a WTRU (e.g., that is in RRC connected) may be pre-configured with a (e.g., different) behavior for relay selection. The WTRU may be configured with a subset of relay WTRUs from which it can select. This additional information may be provided by the network and/or gNB. The WTRU may use (e.g., be restricted to) this set, for example, while in RRC connection stage or for a fixed duration after connection establishment. Link quality to the relay WTRU and/or Uu link quality may be used to determine which behavior to follow. The WTRU may select from this pre-configured set, for example, if the Uu link quality is above a certain threshold value. The WTRU may (e.g., be free to) choose (e.g., any) a relay WTRU, for example, if the Uu link quality falls below a (e.g., some) threshold.

A WTRU can determine its relay selection behavior (e.g., restrictions) and/or network interaction based on resource allocation. In examples, a WTRU that is in coverage and operating under Mode 1 may wait for network to provide it with a relay WTRU and (e.g., only) start a selection process based on an (e.g., explicit) indication from network to do so or after a time expires (e.g., via a timer), for example, which may be preconfigured by a base station (e.g., gNB). A WTRU in coverage and operating in mode 1 may start the selection process by performing measurements and (e.g., potentially) shortlisting and/or reporting a set of candidates. The WTRU may (e.g., only) select a relay WTRU, for example, if it does not receive a relay WTRU from the network (e.g., within a time, for example, via a timer expiration) or do so if it receives a (e.g., explicit) trigger from the network/gNB to do so. In examples, a WTRU that is in coverage may refrain from partaking (e.g., not partake) in discovery (e.g., unless indicated to by the network). A WTRU may choose to refrain from partaking (e.g., not partake) in discovery procedure (e.g., forwarding messages), for example, based on one or more of the following: CBR, QoS requirements, relay load, distance/hop count to source and/or target WTRU, etc. A WTRU may (e.g., choose to) refrain from forwarding (e.g., not forward) any discovery related messages, for example, if it is aware of other relay WTRUs that may be in close proximity to the source/target WTRU and may also use additional information as mentioned above (e.g., CBR, relay load, etc.)

A WTRU can determine its relay selection behavior (e.g., restrictions) and/or network interaction based on the QoS of data. A WTRU may determine the relay selection behavior based on QoS of data being served. A WTRU may receive configuration information indicating (e.g., be configured with) a (e.g., specific) set of relays to choose from (e.g., if/when serving high QoS data). The WTRU may receive configuration information indicating (e.g., be configured with) a different set or alternatively have no restriction and may select from (e.g., all) other relays for lower QoS data.

A WTRU in coverage may initiate a (e.g., RRC) connection or trigger a (e.g., RRC) message, for example, based on WTRU to WTRU relaying criteria.

WTRU to WTRU relaying criteria, failure to connect to a relay WTRU, and/or other events related to WTRU to WTRU relaying may initiate (e.g., additional) signaling at the remote WTRU and/or initiate a connection establishment procedure for a remote WTRU (e.g., in IDLE/INACTIVE). Performing such messaging/connection may be conditioned on the remote WTRU having received the selected relay WTRU from the network. For example, the remote WTRU may receive a relay to be used for U2U relaying from dedicated (e.g., NW) signaling (e.g., in RRC_CONNECTED). The remote WTRU may be moved to RRC connected. The remote WTRU may initiate RRC_CONNECTED and inform the network of such condition, for example, based on (e.g., some) conditions related to the U2U relay WTRU. Such conditions can include one or more of the following: the SL RSRP of the relay WTRU falls below a threshold; the remote WTRU initiates/triggers relay reselection; the remote WTRU detects SL-RLF with the relay WTRU; the remote WTRU is unable to successfully initiate a unicast link with the relay or with the target WTRU via the relay; an alternate relay WTRU measurements become better (e.g., by a threshold) than the current relay WTRU; and/or the like.

A WTRU may be preconfigured to provide the network with a report, for example, if it is unable to connect to any of the configured relays. The WTRU may (e.g., attempt to) connect to another (e.g., any) set of available relays and provide another report, for example, if it is (e.g., still) unable to connect to (e.g., all) the available relays. The network/gNB may provide the WTRU with a (e.g., new) set of relays or indicate to the WTRU that it may (e.g., attempt to) connect to (e.g., any) a relay (e.g., if not already enabled to do so).

A WTRU that is unable to connect to a (e.g., any) relay and sends an indication to the network may wait for a response (e.g., explicit response) from the network, for example, before taking (e.g., any additional) actions or may (e.g., only) attempt to do so after some time duration (e.g., via a timer). The network may inform the WTRU to refrain from attempting (e.g., not attempt any) additional discovery and/or selection, for example, until (e.g., explicitly) indicated to do so.

The network may indicate to a WTRU (e.g., configure a WTRU with) a default or fallback relay, for example, that may be utilized in case the WTRU is unable to connect to a (e.g., any) relay. The network may provide the WTRU with the relay it may utilize for this purpose. The gNB may explicitly indicate to the WTRU if (e.g., when) it should utilize this relay (e.g., based on Uu RSRP threshold falls below some value etc.) The gNB may indicate a duration (e.g., for how long) the WTRU should utilize this relay, for example, explicitly via indication or implicitly where the WTRU comes out of this fallback behavior at the expiration of a time (e.g., via a timer) or once it is able to select a candidate on its own.

A remote WTRU that triggers relay (re) selection (e.g., PC5 link quality) may trigger an RRC connection.

A WTRU may receive configuration information indicating (e.g., be configured with) a threshold (e.g., potentially different from PC5 quality for WTRU reselection), which may trigger a (e.g., RRC) setup/connection initiation message. The remote WTRU in IDLE/INACTIVE may initiate an RRC Connection and transmit a (e.g., RRC) message to the network indicating such, for example, if the measured RSRP of the relay falls below a threshold.

A WTRU that may be unable to find a relay WTRU for selection (e.g., due to unsatisfactory PC5 link quality for any available relay or the fact that it has been configured with set of allowable relays but was unable to select any one of these due to unsatisfactory link quality) may trigger an RRC connection.

A WTRU with (e.g., multiple) candidates that satisfy reselection criteria may trigger a (e.g., RRC) message from the base station (e.g., gNB), for example, to provide some additional information in terms of which relay the WTRU should select. The gNB may be able to provide this information, for example, based on any additional information that it may be aware of regarding relay state (e.g., relay load, number of active connections etc.)

The WTRUs location (e.g., with respect to relay WTRU candidates) may result in a (e.g., RRC) connection request. A (e.g., RRC) connection request may be triggered, for example, if there is a mismatch in the WTRUs location (e.g., based on its grid or zone ID etc.) and that of the relay WTRU candidate(s), or if the distance between the WTRU and relay WTRU is above a (e.g., some) threshold.

The WTRU may initiate a (e.g., RRC) connection from the gNB/network, for example, if a unicast link setup between the WTRU and a relay that was selected by network is unsuccessful.

A WTRU that has refrained from performing (e.g., has not performed) transmissions (e.g., any transmissions) or received (e.g., any) receptions from a WTRU (e.g., relay WTRU) may trigger a relay reselection (e.g., based on inactivity time, for example, via a timer), which may then result in the WTRU requesting a (e.g., RRC) connection.

A U2U relay WTRU may transmit a request for a (e.g., RRC) connection, for example, based on the relay state (e.g., if relay load increases or decreases below some threshold, the number of active relay connections that this relay is maintaining goes above some set threshold, the data rate of relayed traffic crosses some threshold value, the QoS of the data that it is relaying, hop count to the source/target, etc.).

The coverage scenario of the WTRU(s) may result in the relay WTRU requesting a (e.g., RRC) connection. A relay WTRU that is in IDLE/INACTIVE state and is aware of another WTRU's cell ID (e.g., via PC5-RRC message) may request a (e.g., RRC) connection, for example, if the Cell ID differs from its own. A remote WTRU may receive configuration information indicating (e.g., be configured with) a list of relay WTRUs to which reselection may be enabled (e.g., is allowed). The remote WTRU may trigger a (e.g., RRC) connection, for example, if the remote WTRU performs relay reselection to a relay which falls outside of that list or if the remote WTRU performs relay reselection to a relay WTRU which is connected/camped to a different cell than the remote WTRU.

A WTRU that triggers a reselection event may report these events to the network.

A WTRU that performs reselection may shortlist a primary and secondary relay. The secondary relay may be a backup relay that may be kept on hand, for example, in case the primary relay fails. The WTRU may report this secondary relay to the network. The WTRU may receive configuration information indicating (e.g., be configured by the network) to report this, for example, either explicitly (e.g., configuration of multiple RSRP thresholds for the WTRU) or implicitly (e.g., additional differentiating factors regarding primary and secondary relays both satisfy PC5 link quality requirements, but additional factors such as relay load, supported QoS, hop count/distance to target are split across the relay candidates).

A WTRU (e.g., relay WTRU) may refrain from forwarding (e.g., choose to not forward) a discovery message (e.g., based on traffic QoS of needs, CBR, CR, relay load, distance to source/destination, hop count etc.). The relay WTRU may report/indicate this to the network.

A remote WTRU performing (e.g., PC5) link quality measurements (e.g., SD-RSRP or SL-RSRP), may provide an indication that may indicate (e.g., of the fact) that different links may have different frequency of transmissions, which may, for example, imply different age of the (e.g., each) PC5 link quality measurement. The WTRU may report, for example, if its choice of relay was affected by this information, e.g., if the WTRU chose a relay that did not (e.g., necessarily) have the strongest RSRP measurement (e.g., because the measurement was based on older information compared to another PC5 relay link).

A WTRU (e.g., remote WTRU) may report to the network, for example, if its measurements result indicates that no relay link quality is above the (e.g., minimum) link quality threshold. If the number of relays that satisfy the (e.g., minimum) threshold is below a threshold (e.g., only one relay WTRU is eligible for selection), the WTRU may indicate this information to the network and wait for a response (e.g., explicit indication by network to go ahead or implicit based on a time expiration), for example, before choosing this relay for re-selection.

The WTRU may report measurements to the network, for example, based on (e.g., multiple) hops.

The WTRU may receive configuration information indicating (e.g., be configured) to report (e.g., certain) measurements to the network.

The remote or relay WTRU may receive configuration information indicating (e.g., be configured) to report measurements over a (e.g., more than one) hop/link (e.g., source to U2U relay as well as U2U relay to target/destination WTRU hop). The link quality of the relay to the destination may be based on a direct link to the target or path via (e.g., multiple) U2U relays. The measurement between relay and destination/target WTRU may be received (e.g., via a PC5-RRC message) and may include measurements over (e.g., all additional) U2U relay hops (e.g., if there are multiple U2U relays in the path). In this case, the reported measurement may be based on a combination (e.g., maximum/minimum/average measurement) of measurements over (e.g., all) the intermediate hops (e.g., from relay to destination WTRU). The source may combine the measurement(s) to the relay and from the relay to the destination (e.g., in any way, such as, for example, maximum/minimum/average etc.) just as done by the relay WTRU.

Reception of a link related measurement from a relay WTRU (e.g., relay WTRU to target WTRU side link measurement as described herein) may trigger a measurement report from the source WTRU.

A relay WTRU may receive configuration information indicating (e.g., configuring the relay WTRU) to report the measurement to the network. The relay WTRU may (e.g., based on the configuration information) report the measurement to the network. This measurement may be triggered by a (e.g., certain) condition(s), for example, on either hop

A measured link quality (e.g., SL-RSRP/SD-RSRP) on either hop (e.g., remote WTRU-relay WTRU and/or relay WTRU-target WTRU RSRP going below a configured threshold value) may trigger a measurement report to the network.

A measurement report to the network may be triggered, for example, if the SL measurement at relay WTRU provides the relay WTRU with information regarding locations of the source and destination WTRU (e.g., the absolute distance between the source and destination or relative distance possibly with respect to itself), or a zone ID and if this exceeds some threshold (e.g., which may be indicative of availability of a better path) . . . . The distance may be inferred from the sidelink measurement messages between WTRUs (e.g., a time stamp placed at an (e.g., each) originating path, such as a source-relay path, relay-destination path).

Resource pool usage measurements at the relay (e.g., CBR of the resource pool, CR for the relay WTRU) may trigger a measurement report to the network.

The QoS of the various links may trigger the relay WTRU to provide the network with a measurement report. The relay WTRU may be triggered to provide a measurement report, for example, if the relay WTRU observes a drop in link quality that impacts QoS on either or both hops based on some metric (e.g., RSRP, CSI/CQI, latency, etc.) falling below a configured threshold. The relay may be able to observe this change, for example, via a change (e.g., increase) in buffer associated with particular LCGs.

The WTRU may perform relay selection, for example, based on (e.g., existing) unicast links and/or relay need.

A WTRU may use (e.g., in addition to other criteria such as RSRP, load, etc.) the presence of a (e.g., existing) unicast link with a relay and/or between a relay and a destination WTRU as a criterion for relay selection.

A source WTRU that may be (e.g., already) connected to a destination/target WTRU may prioritize that relay path, for example, if (e.g., when) performing re-selection. This may be done, for example, by hysteresis or an offset that favors this path (e.g., over another candidate path) unless the relays link quality has fallen below some preconfigured threshold (e.g., that may be different from the reselection threshold).

A source WTRU may prioritize selection of a relay WTRU (e.g., to reach a specific target) in which a unicast link with the relay WTRU is established (e.g., already exists). For example, the source WTRU may apply a measurement offset to prioritize the relay WTRU with the established (e.g., existing) unicast link over a relay WTRU to which a unicast link is not established (e.g., does not already exist).

A source WTRU may prioritize selection of a relay WTRU that provides U2N relaying service, for example, in addition to U2U relaying service. The source WTRU may perform such prioritization, for example, in case the source WTRU (e.g., already) has ongoing or planned Uu services.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-16. (canceled)

17. A wireless transmit/receive unit (WTRU) comprising:
a processor configured to:
receive configuration information indicating a first threshold, a second threshold, and data transmission gap information;
send a first transmission to a first relay;
determine a reference signal received power (RSRP) associated with the first relay;
determine that the RSRP associated with the first relay is below the first threshold and above the second threshold;
based on the determination that the RSRP associated with the first relay is below the first threshold and above the second threshold:
determine that a data transmission time gap threshold is met, wherein the data transmission time gap threshold is determined based on the data transmission gap information, and
based on the determination that the data transmission gap threshold is met, perform relay reselection to a second relay; and
send a second transmission to the second relay.

18. The WTRU of claim 17, wherein the processor is further configured to:
determine that an RSRP associated with the second relay is below the second threshold; and
based on the determination that the RSRP associated with the second relay is below the second threshold:
perform relay reselection to a third relay, and
send a third transmission to the third relay.

19. The WTRU of claim 17, wherein the determination that the data transmission time gap threshold is met comprises:
a determination of the data transmission time gap threshold based on the data transmission gap information and the RSRP associated with the first relay;
a determination of a duration associated with a data transmission time gap after initiating discovery; and
a determination that the duration is greater than the data transmission time gap threshold.

20. The WTRU of claim 19, wherein a first RSRP is associated with a first data transmission time gap threshold, wherein a second RSRP is associated with a second data transmission time gap threshold, wherein the first RSRP is greater than the second RSRP, and wherein the first data transmission time gap threshold is greater than the second data transmission time gap threshold.

21. The WTRU of claim 19, wherein the duration associated with the data transmission time gap is a duration without a scheduled transmission.

22. The WTRU of claim 17, wherein the first threshold is a first RSRP threshold, wherein the second threshold is a second RSRP threshold, and wherein the first threshold is higher than the second threshold.

23. The WTRU of claim 17, wherein the first relay is a first WTRU-to-WTRU relay, and wherein the second relay is a second WTRU-to-WTRU relay.

24. The WTRU of claim 17, wherein the processor is further configured to:
initiate discovery, wherein the initiation of discovery comprises a transmission of a discovery transmission or a reception of a discovery transmission.

25. A method comprising:
receiving configuration information indicating a first threshold, a second threshold, and data transmission gap information;
sending a first transmission to a first relay;
determining a reference signal received power (RSRP) associated with the first relay;
determining that the RSRP associated with the first relay is below the first threshold and above the second threshold;
based on the determination that the RSRP associated with the first relay is below the first threshold and above the second threshold:
determining that a data transmission time gap threshold is met, wherein the data transmission time gap threshold is associated with the data transmission gap information, and
based on the determination that the data transmission gap threshold is met, performing relay reselection to a second relay; and
sending a second transmission to the second relay.

26. The method of claim 25, wherein the method further comprises:
determining that an RSRP associated with the second relay is below the second threshold; and
based on the determination that the RSRP associated with the second relay is below the second threshold:
performing relay reselection to a third relay, and
sending a third transmission to the third relay.

27. The method of claim 25, wherein the determination that the data transmission time gap threshold is met comprises:
determining the data transmission time gap threshold based on the data transmission gap information and the RSRP associated with the first relay;
determining a duration associated with a data transmission time gap after initiating discovery; and
determining that the duration is greater than the data transmission time gap threshold.

28. The method of claim 27, wherein a first RSRP is associated with a first data transmission time gap threshold, wherein a second RSRP is associated with a second data transmission time gap threshold, wherein the first RSRP is greater than the second RSRP, and wherein the first data transmission time gap threshold is greater than the second data transmission time gap threshold.

29. The method of claim 27, wherein the duration associated with the data transmission time gap is a duration without a scheduled transmission.

30. The method of claim 25, wherein the first threshold is a first RSRP threshold, wherein the second threshold is a second RSRP threshold, and wherein the first threshold is higher than the second threshold.

31. The method of claim 25, wherein the first relay is a first WTRU-to-WTRU relay, and wherein the second relay is a second WTRU-to-WTRU relay.

32. The method of claim 25, wherein the method further comprises:
initiating discovery, wherein initiating discovery comprises a transmission of a discovery transmission or a reception of a discovery transmission.
